(19) United States
(12) Patent Application Publication
(10) Pub. No.: US 2023/0105322 A1
(43) Pub. Date: Apr. 6, 2023

(54) SYSTEMS AND METHODS FOR LEARNING RICH NEAREST NEIGHBOR REPRESENTATIONS FROM SELF-SUPERVISED ENSEMBLES

(71) Applicant: salesforce.com, inc., San Francisco, CA (US)

(72) Inventors: Bram Wallace, New York, NY (US); Devansh Arpit, Pacifica, CA (US); Huan Wang, Fremont, CA (US); Caiming Xiong, Menlo Park, CA (US)

(21) Appl. No.: 17/588,066

(22) Filed: Jan. 28, 2022

Related U.S. Application Data
(60) Provisional application No. 63/252,505, filed on Oct. 5, 2021.

(51) Int. Cl. G06N 3/08; G06N 3/04

(52) U.S. Cl. CPC G06N 3/08; G06N 3/0454; G06V 10/82

(57) ABSTRACT

Embodiments described herein provide a system and method for extracting information. The system receives, via a communication interface, a dataset of a plurality of data samples. The system determines, in response to an input data sample from the dataset, a set of feature vectors via a plurality of pre-trained feature extractors, respectively. The system retrieves a set of memory bank vectors that correspond to the input data sample. The system, generates, via a plurality of Multi-Layer-Perceptrons (MLPs), a mapped set of representations in response to an input of the set of memory bank vectors, respectively. The system determines a loss objective between the set of feature vectors and the combination of the mapped set of representations and a network of layers in the MLP. The system updates, the parameters of the plurality of MLPs and the parameters of the memory bank vectors by minimizing the computed loss objective.

### PRIORITY

The present disclosure claims priority the U.S. Provisional Application No. 63/252,505, filed on Oct. 5, 2021, which is hereby expressly incorporated by reference herein in its entirety.

### TECHNICAL FIELD

The embodiments relate generally to machine learning systems, and more specifically to a mechanism for ensembling self-supervised models.

### BACKGROUND

Ensembling models such as a plurality of convolutional neural network models is commonly used in supervised learning. Ensembling involves combining the predictions obtained from the plurality of convolutional neural network models. For example, in the supervised setting, ensembling models may be performed using concatenation or averaging the features. In supervised learning the output of the models is aligned and the concatenation or averaging often captures the combined knowledge of the ensembled models. However, ensembling models using self-supervised learning such alignment is difficult.

Therefore, there is a need to ensemble models with self-supervised learning that are aligned such that the ensembled self-supervised models capture the combined knowledge of the ensembled models.

### BRIEF DESCRIPTION OF THE DRAWINGS

FIG. 1 is a simplified diagram illustrating an example system for training a model for computing an ensemble vector representation of a plurality of pre-trained feature extractors, according to one embodiment described herein.

FIG. 2 is a simplified diagram illustrating an example architecture for training an ensemble vector of a query datapoint, via a pre-trained model according to one embodiment described herein.

FIG. 3 is a simplified diagram of a computing device that implements the system that trains a model for computing an ensemble vector representation of a plurality of pre-trained feature extractors, according to some embodiments described herein.

FIG. 4A is a simplified logic flow diagram illustrating an example process for training a model for computing an ensemble vector representation of a plurality of pre-trained feature extractors using the framework shown in FIG. 1, according to embodiments described herein.

FIG. 4B is a simplified pseudocode illustrating an example process corresponding to process, according to embodiments described herein.

FIG. 5A is a simplified logic flow diagram illustrating an example process for computing via a trained model an ensemble vector representation of a plurality of pre-trained feature vectors using the framework shown in FIG. 2, according to embodiments described herein.

FIG. 5B is a simplified pseudocode illustrating an example process corresponding to process in FIG. 5A, according to embodiments described herein.

FIGS. 6-15 provide various data tables and plots illustrating example performance of a trained model for computing an ensemble vector representation of a plurality of pre-trained feature vector extractors using the framework shown in FIGS. 1-2 and/or method described in FIGS. 1-8, according to one embodiment described herein.

In the figures, elements having the same designations have the same or similar functions.

### DETAILED DESCRIPTION

As used herein, the term “network” may comprise any hardware or software-based framework that includes any artificial intelligence network or system, neural network, or system and/or any training or learning models implemented thereon or therewith.

As used herein, the term “module” may comprise hardware or software-based framework that performs one or more functions. In some embodiments, the module may be implemented on one or more neural networks.

Ensembling models such as a plurality of convolutional neural network models is commonly used in supervised learning. Ensembling involves combining the predictions obtained from the plurality of convolutional neural network models. For example, in the supervised setting, ensembling models may be performed using concatenation or averaging the features. In supervised learning the output of the models is aligned and the concatenation or averaging often captures the combined knowledge of the ensembled models.

However, when ensembling models using self-supervised learning such alignment is difficult. For example, the output of the models may have different dimensions. In some models where the alignment is feasible, the resulting ensemble representation may not be superior in representation quality to compared to the individual representations from the original models, i.e., the models do not capture the combined knowledge of the ensembled models. Embodiments described herein provide an ensembling framework of training an ensembled unsupervised representation model to determine an optimized output representation of input data samples. Specifically, a plurality of pre-trained feature extractors is adopted to obtain a set of feature vectors that correspond to a set of training images, respectively. A plurality of multi-layer perceptrons (MLPs) are then used to determine a mapped representation of a set of memory bank feature vectors. In an example, the set of memory bank feature vectors may be feature vectors from a trained Stochastic Gradient Descent (SGD) learned deep neural network where each feature vector corresponds to a data sample from the dataset. The MLPs and the set of memory bank feature vectors are then updated by maximizing the cosine similarity between the set of feature vectors and the combination of the mapped representation and the MLP network.

For example, when a number of encoder models (e.g., image feature extractors) are to be ensembled over a training dataset of images, the same number of MLPs may be trained to reconstruct the features supervised by the feature extractor outputs. The MLPs are initialized as well as learned representations of the training images, which may take a form as memory bank vectors. In other words, the training objective is for all of the features extracted from the number of encoder models to be recoverable by feeding learned representations through the respective MLP. To achieve that, the MLPs transforms the learned representations into reconstructed features. A cosine loss is then computed between the reconstructed features and the features from the feature extractors. Both the MLPs and the learned representations are updated via gradient descent based on the cosine loss.

At inference time, an input image is encoded by the number of encoder models into feature ground truths, and a learned representation is transformed by the trained MLPs into reconstructed features in a similar manner as in the training stage. A cosine loss is then similarly computed between the reconstructed features from the trained MLPs and the features from the feature extractors. The trained MLPs are frozen while the learned representation is updated by the cosine loss via gradient descent. The updated (optimized) learned representation is then the output of ensembled encoder models.

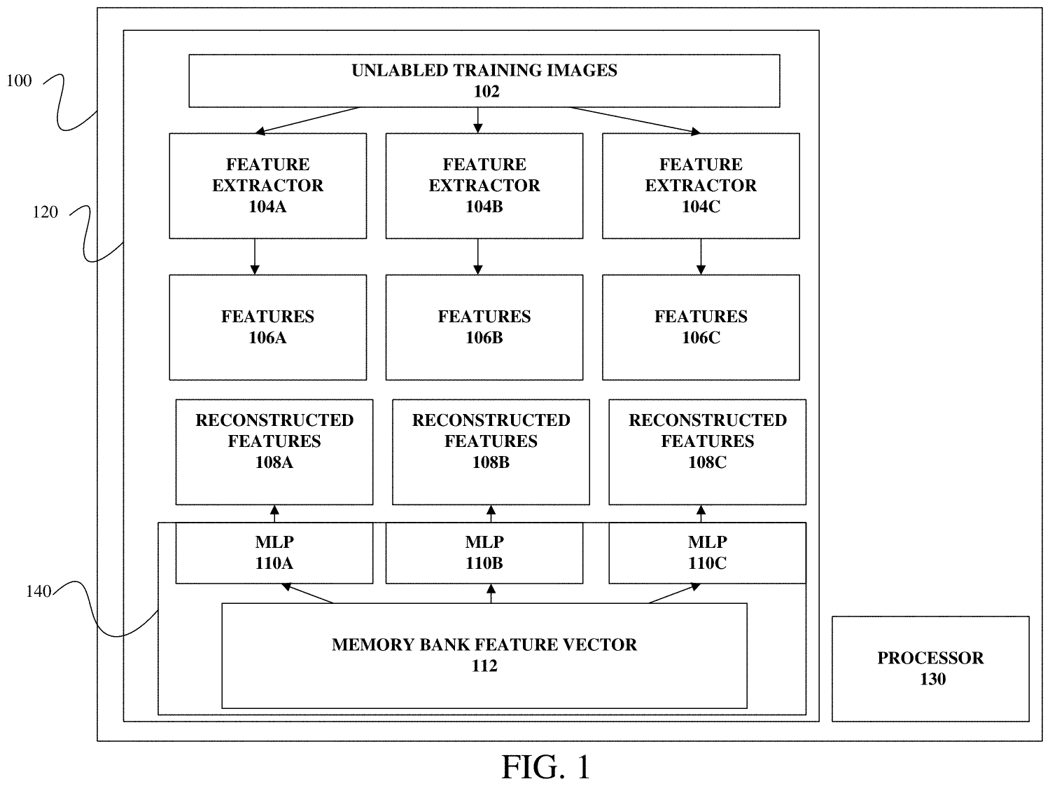

FIG. 1 is a simplified diagram illustrating an example architecture for ensembling multiple models at training stage, according to one embodiment described herein. As shown in FIG. 1, a system 100 include a processor 110 and a memory 120 In an example, the memory 120 may store one or more models.

In an example, the memory 120 may store a plurality of pre-trained feature extractors 104A-104C, that generate features 106A in response to receiving a dataset of datapoints 102. In an example, the dataset of datapoints 103 may be a set of unlabeled training images 102, a set of documents, an audio file or both.

In an example, the pretrained feature extractors 104A-104C, i.e., Θ may include convolutional neural networks, such as ResNet 50 with features extracted between the stem and head of the network that have had pretraining on ImageNet. In an example, the method used in pretraining may varies. In an example, the methods for pre-training may include SimCLR(v2), SwAV, Barlow Twins, PIRL, Learning by Rotation (RotNet trained on ImageNet-22k): https://dl.fbaipublicfiles.com/vissl/model_zoo/converted_vissl_rn50_rotnet_in22k_ep105.to rch, and (Gidaris et al. 2018, Unsupervised representation learning by predicting image rotations. In International Conference on Learning Representations, URL https://openreview.net/forum?id=S1v4N210-), and supervised classification. In an example, the pretrained feature extractors 104A-104C may be obtained from the VISSL Model Zoo (Goyal et al. 2021) via the communication interface.

In an example, the memory 120 may store a plurality of Multi-Layer-Perceptrons (MLPs) 110A-110C. In an example, the plurality of MLP's 110A-110C may correspond a feature extractor in the plurality of pre-trained feature extractors 104A-104C.

In an example, the system 100 may receive the dataset of datapoints 102 via a communication interface. In example, the dataset of datapoints 102 may be a set of files that includes data. Examples, of the dataset of datapoints 102 includes a set of images, a set of text documents, a set of audio documents, a set of point clouds, or a set of polygon meshes. In an example, the dataset of datapoints 102 may be a set of 3D objects that are represented via a polygon mesh. In an example, the dataset of datapoints 102 may be a set of 2D objects that are represented via a point cloud. In an example, the system 100 may receive the dataset of datapoints 102 such as a training collection of images X={xᵢ}ᵢ₌₁ⁿ and the plurality of pre-trained feature extractors 104A-104C such as an ensemble of convolutional neural networks feature extractors Θ={θⱼ}ⱼ₌₁^{m}.

In an example, the pre-trained feature extractors 104A-104C, such as θⱼ may include previously trained self-supervised feature extractors. For example, the pre-trained feature extractors 104A-104C may be trained on ImageNet classification and may be ResNet-50s (Deng et al. 2009 A large-scale hierarchical image database. In 2009 IEEE conference on computer vision and pattern recognition, pp. 248-255, Ieee, 2009 and He et al. In Proceedings of the IEEE conference on computer vision and pattern recognition, pp. 770-778, 2016).

In an example, the features 106A-C may include L2-normalized features obtained by removing the linear/MLP heads of these networks and extracting intermediate features post-pooling (and ReLU) as

Z={{zᵢ^{(j)}}ᵢ₌₁ⁿ}ⱼ₌₁^{m}, where zᵢ^{(j)} denotes the intermediate features 106A-C corresponding to θⱼ(xᵢ).

In an example, they system 100 initializes a memory bank of feature vectors 112 such as X, with one entry for each xᵢ such that the entries have the same feature dimensionality as the intermediate feature vectors 106A-106C such as zᵢ^{j}. In an example, the memory bank of feature vectors 112 is similar to the type use in early contrastive learning such as Wu et al. 2018.

In an example, the memory bank feature vectors 112 may be represented as:

Ψ={ψₖ}ₖ₌₁ⁿ where each ψₖ is initialized to the L2-normalized average representation of the ensemble

$${ψ}_{k} = \frac{{\sum }_{j = 1}^{m} {z}_{k}^{j}}{\vert {\sum }_{j = 1}^{m} {z}_{k}^{j} \vert} .$$

In an example, the sum operation in the average representation ensemble is equivalent to averaging due to the normalization being performed.

In an example, the system maps the memory bank feature vectors 112 to the ensembled features 108A-C, via a set of multi-layer perceptrons (MLPs) 110A-C, Φ={ϕₗ}ₗ₌₁^{m}, each corresponding to a feature extractor θⱼ. In an example, the MLPs 110A-C ϕₗ are two layers such that both of output dimension the same as their input (2048 for ResNet50 features). In an example, ReLU activations may be used after both layers. For example, the first ReLU activation may be a traditional activation function, and the second ReLU activation may be to align the network in mapping to the post-ReLU set Z.

In an example, at training stage, the system 100 may train the model 140 based on a batch of images {xᵢ}_{i∈I} that are sampled with indices I⊂{1 . . . n}. In an example, the system 100 may determine via the plurality of pre-trained feature extractors 104A-104C the corresponding ensemble features 106A-106C represented as:

Z_{I}={{zᵢ^{(j)}}_{i∈I}}ⱼ₌₁^{m}.

The system 100 may also retrieve the memory bank feature vectors 112, i.e., Ψ_{I}={ψₖ}_{k∈I}. In an example, the system 100 may not perform an image augmentation. In other words, the system 100 may cache the ensemble features 106A-106C zᵢ^{(j)} to reduce the computational complexity. In an example, the system 100 may feed each of the memory bank feature vectors 112 through each of the m MLPs 110A-110C, Φ to determine a set of mapped representations, such as the reconstructed features 108A. The reconstructed features 108A may be represented as Φ(Ψ_{I})={ϕₗ(ψᵢ)}_{l∈{1 . . . m},i∈I}. In an example, the system 100 may maximize the alignment of these mapped features such as the reconstructed features 108A Φ(Ψ_{I}) with the original ensemble features such as the features 106A-C represented as Z_{I}.

In an example, the system may update both the networks such as the MLPS 110A-110C represented as Φ and the memory bank feature vectors 112, i.e., Ψ using a cosine loss between the reconstructed features 108, i.e., Φ(Ψ_{I}) and the original ensemble features 106A-C, i.e., Z_{I}. In an example, the system may compute gradients for both the MLPs and memory bank feature vectors 112 for each batch.

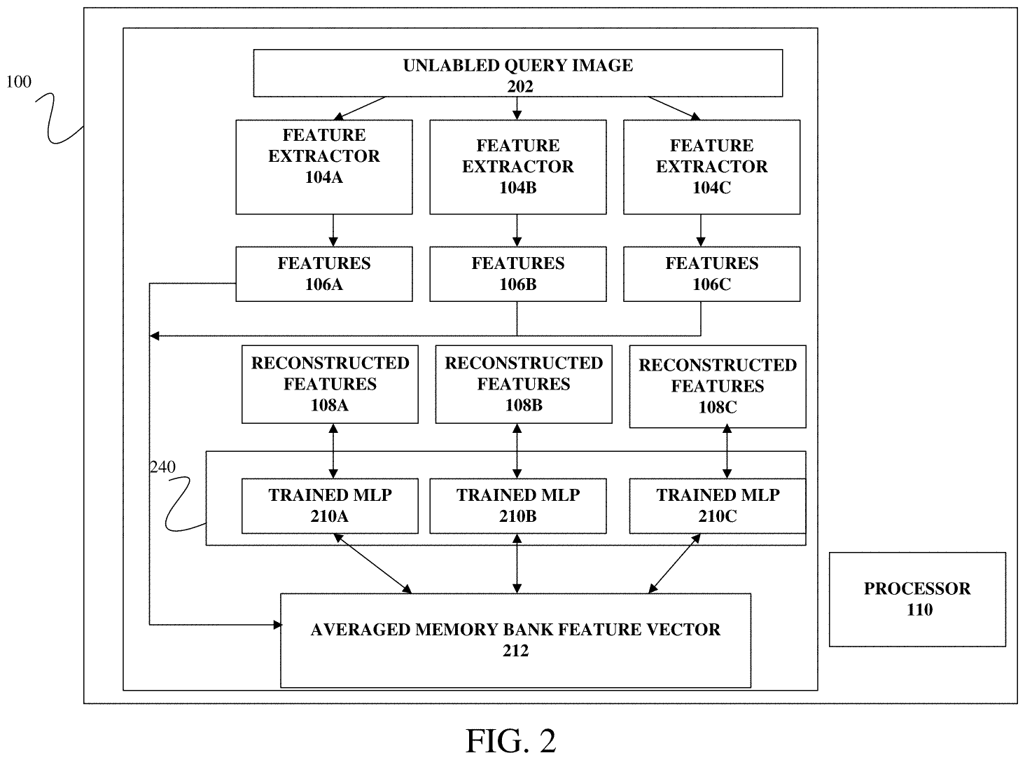

FIG. 2 is a simplified diagram illustrating an example architecture for generating an output of ensembled models in response to an input query at inference stage, according to one embodiment described herein. After the training stage described in relation to FIG. 1, a plurality of trained MLPs 210A-C is stored in the memory 110.

In an example, the MLPs 210A-210C correspond to the plurality of pre-trained feature extractors 104A-C that generate features 106A-106C in response to receiving an unlabeled datapoint 202 via a communication interface. In an example, the unlabeled datapoint 202 may be an image, a document, or an audio file.

In an example, the system 100 after training freezes the plurality of trained MLP's 210A-210C, i.e., ϕₗ. During inference, when a new image x′ is received, the new image is encoded by the feature extractors 104A-C into features 106A-C, in a similar way that a training image is encoded as described in FIG. 1.

Specifically, the system 100 determines the features 106A-106C via the plurality of pre-trained feature extractors 104A-104C. The features 106A-106C may be represented as ϕₗ(x′) and the features may be averaged to initialize an average memory bank feature vector 212 that may be represented as ψ′·ψ′.

Similarly, the initialized average memory bank feature vector 212 is passed to the trained MLPs 210A-C to be encoded into reconstructed features 108A-C, in a similar way as described in FIG. 1. A cosine loss is similarly computed between the reconstructed features 108A-C and the features 106A-C as described in FIG. 1. However, during inference, only the memory bank feature vector 212 is updated via gradient descent to maximize the cosine similarity loss of each of the plurality of features 108A-C, i.e., ϕₗ(ψ′) with each of the features 106A-C θₗ(x′), ψ′, while parameters of trained MLPs 210A-210C are frozen. The updated memory bank feature vector 212 then serves as the representation of x′, i.e., as an optimized ensemble vector that corresponds to the output of the plurality of feature extractors 104A-C.

In an example, the system 100 may obtain ensemble trained memory bank feature vector 212 that may be superior to the average features, concatenated features, or both in terms of nearest-neighbor accuracy.

It is noted that in both FIGS. 1-2, three feature extractors 104A-C (and correspondingly three MLPs) are shown for illustrative purpose only. Any other number of feature extractors or other encoder models may be ensembled using similar structure and/or process described in relation to FIGS. 1-2.

### Computing Environment

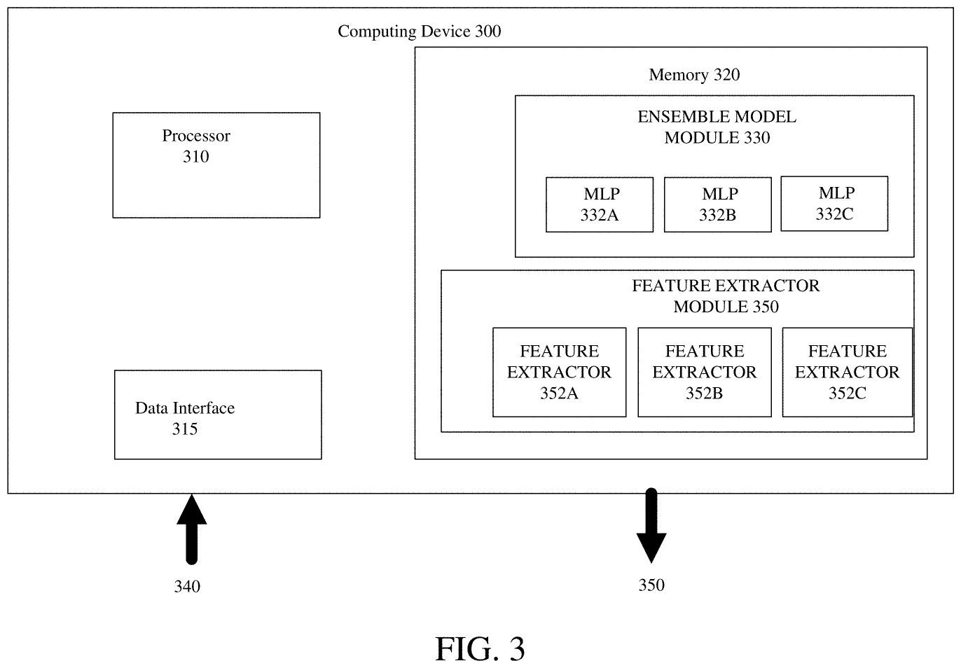

FIG. 3 is a simplified diagram of a computing device that implements a method of training a model for computing an ensemble vector representation of a plurality of pre-trained feature extractors, according to some embodiments described herein. As shown in FIG. 3, computing device 300 includes a processor 310 coupled to memory 320. Operation of computing device 300 is controlled by processor 310. And although computing device 300 is shown with only one processor 310, it is understood that processor 310 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 600. Computing device 300 may be implemented as a stand-alone subsystem, as a board added to a computing device, and/or as a virtual machine.

Memory 320 may be used to store software executed by computing device 300 and/or one or more data structures used during operation of computing device 300. Memory 320 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip, or cartridge, and/or any other medium from which a processor or computer is adapted to read.

Processor 310 and/or memory 320 may be arranged in any suitable physical arrangement. In some embodiments, processor 310 and/or memory 320 may be implemented on a same board, in a same package (e.g., system-in-package), on a same chip (e.g., system-on-chip), and/or the like. In some embodiments, processor 310 and/or memory 320 may include distributed, virtualized, and/or containerized computing resources. Consistent with such embodiments, processor 310 and/or memory 320 may be in one or more data centers and/or cloud computing facilities.

In some examples, memory 320 may include non-transitory, tangible, machine readable media that includes executable code that when run by one or more processors (e.g., processor 310) may cause the one or more processors to perform the methods described in further detail herein. For example, as shown, memory 320 includes instructions for an ensemble model module 330 that may be used to implement and/or emulate the systems and models, and/or to implement any of the methods described further herein. In some examples, the ensemble model module 330, may receive an input 340, e.g., such as a question, via a data interface 315. The data interface 315 may be any of a user interface that receives a question, or a communication interface that may receive or retrieve a previously stored question from the database. The ensemble model module 630 may generate an output 350, such as an answer to the input 340.

In one embodiment, memory 320 may store an ensemble model module, such as the model described in FIG. 2. In another embodiment, processor 310 may access a knowledge base stored at a remote server via the communication interface 315.

In some embodiments, the ensemble model module 330 may further include an MLP module (shown as MLP 332A-332C) and a bank feature vector module. The MLP (which is like the MLP layer in FIGS. 1-2) is configured to determine a reconstructed feature vector 108A-C in FIG. 1. The bank feature vector module (which is like the memory bank feature vectors 112 in FIG. 1-2) is configured to represent an ensemble vector representation of a datapoint in a dataset.

In one implementation, the ensemble model module 330 and its submodules 331-332 may be implemented via software, hardware and/or a combination thereof.

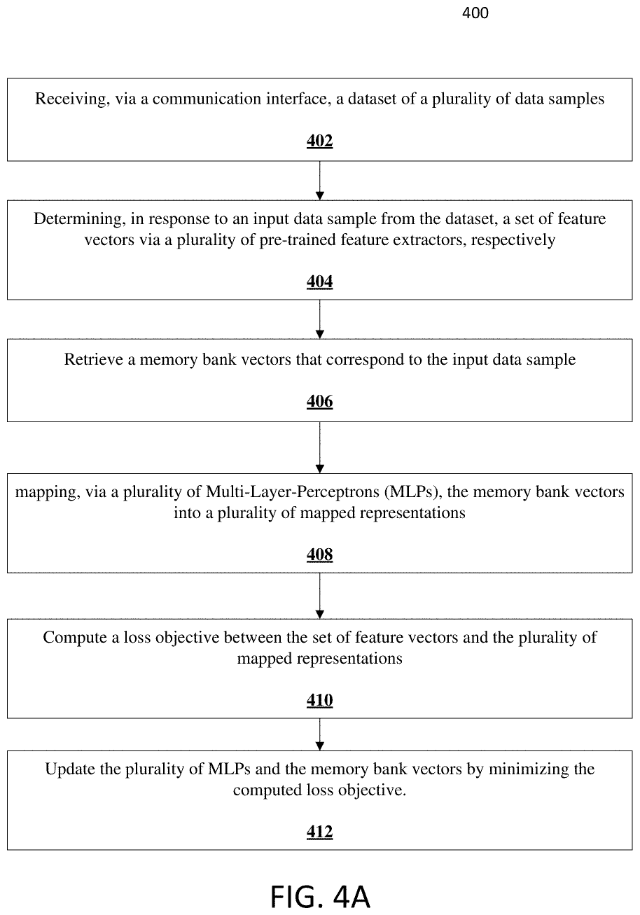

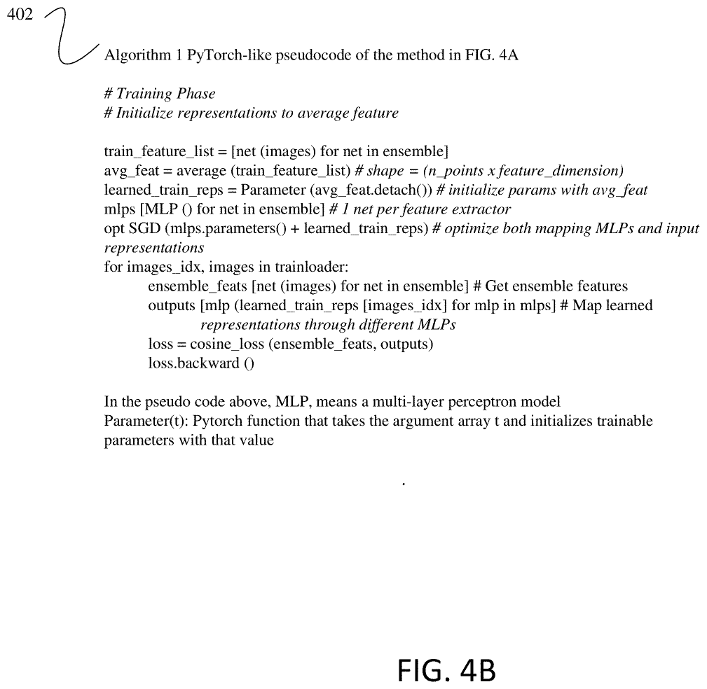

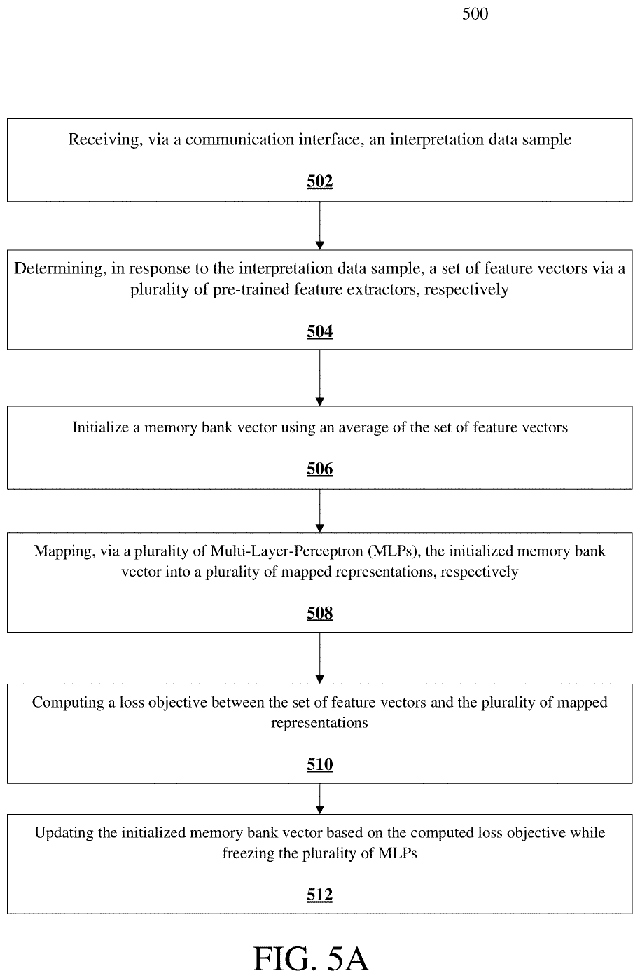

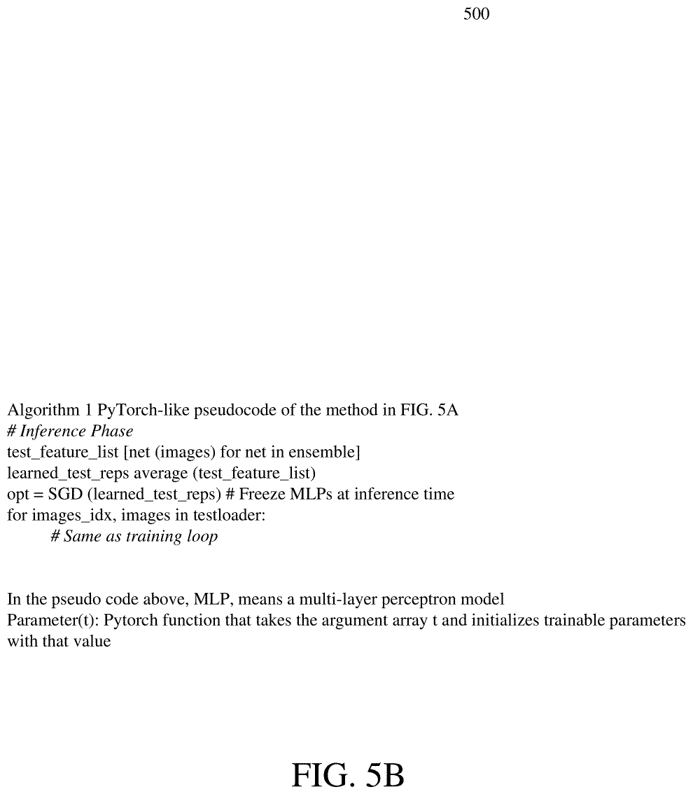

Some examples of computing devices, such as computing device 300 may include non-transitory, tangible, machine readable media that include executable code that when run by one or more processors (e.g., processor 310) may cause the one or more processors to perform the processes of methods 400-500 discussed in relation to FIGS. 4-5. Some common forms of machine readable media that may include the processes of methods 400-500 are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

### Example Workflows

FIG. 4A is a simplified logic flow diagram illustrating an example process 400 for training a model for computing an ensemble vector representation of a plurality of pre-trained feature extractors using the framework shown in FIG. 1, according to embodiments described herein. One or more of the processes of method 400 may be implemented, at least in part, in the form of executable code stored on non-transitory, tangible, machine-readable media that when run by one or more processors may cause the one or more processors to perform one or more of the processes. In some embodiments, method 400 corresponds to the operation of the ensemble model module 430 (FIG. 4) to perform the task of providing an answer to an input question.

At step 402, a dataset of a plurality of data samples (e.g., 102 in FIG. 1) is received via a communication interface (e.g., 315 in FIG. 3). For example, the set of unlabeled training images 102 for supervised learning is received.

At step 404, a set of feature vectors are determined based on a sample from the dataset of data samples. For example, module 330 may determine, via a plurality of pre-trained feature extractors (e.g., 104A-104C in FIG. 1) a set of feature vectors.

At step 406, a set of memory bank vectors (e.g., 112) may be retrieved. For example, a memory bank vector that are initialized based on an (SGD) learned deep neural network deep network as described above with reference to FIG. 1 may be retrieved. In an example, the memory bank vector may correspond to the data sample in the dataset. In an example, the system 100 (as shown in FIG. 1) may determining a memory bank vector corresponding to the plurality of data samples from the dataset from a pre-trained deep learning network.

At step 408, a plurality of MLPs (e.g., 110A-110C in FIG. 1) may map the memory bank vector into a plurality of mapped representations. For example, the plurality of MLPs maps the memory bank feature vector 112 in combination with the MLPs (e.g., 110A-110C in FIG. 1) to reconstructed features (e.g., 108A-108C in FIG. 1).

At step 410, a loss objective between the set of feature vectors and the plurality of mapped representations is determined. For example, the loss objective between the features (e.g., 106A-C) and the mapped combination of reconstructed feature vectors (e.g., 108A) in combination with a network of layers in the MLPs (e.g., 110A-110C in FIG. 1) is computed.

At step 412, the plurality of MLPs (e.g., 110A-110C in FIG. 1) and the memory bank vectors (e.g., 112 in FIG. 1) are updated by minimizing the computed loss objective.

FIG. 4B is a simplified pseudocode illustrating an example process corresponding to process 400 in FIG. 4A for training a model for computing an ensemble vector representation of a plurality of pre-trained feature extractors, according to embodiments described herein. In an example, the system 100 as shown in FIG. 1, may include code for training the model. The system 100 may include a set of machine learning instructions that may be interpreted by the processor to train the model as described above with reference to FIG. 4A.

FIG. 5A is a simplified logic flow diagram illustrating an example process 500 for computing via a trained model an ensemble vector representation of a plurality of pre-trained feature vectors using the framework shown in FIG. 2, according to embodiments described herein. One or more of the processes of method 500 may be implemented, at least in part, in the form of executable code stored on non-transitory, tangible, machine-readable media that when run by one or more processors may cause the one or more processors to perform one or more of the processes. In some embodiments, method 500 corresponds to the operation of the ensemble model module 330 (FIG. 3) to perform the task of providing an answer to an input question.

At step 502, an interpretation data sample (e.g., 202 in FIG. 2) is received via a communication interface (e.g., 315 in FIG. 3). For example, the set of unlabeled query image 202 is received.

At step 504, a set of feature vectors are determined based on a sample from the dataset of data samples. For example, module 330 may determine, via a plurality of pre-trained feature extractors (e.g., 104A-104C in FIG. 1) a set of feature vectors (e.g., 106A-106C).

At step 506, an average set of feature vectors (e.g., 212 in FIG. 2) may be computed. For example, an average set of feature vectors (e.g., 212 in FIG. 2) may be generated by averaging the set of feature vectors (e.g., 106A-106C in FIG. 2), wherein the dimensions of the average set of feature vectors correspond to the dimensions of the set of memory bank vectors.

At step 408, a plurality of MLPs (e.g., 110A-110C in FIG. 2) may generate a mapped set of representations in response to the average set of memory bank vectors, respectively. For example, the plurality of MLPs maps the average memory bank feature vectors (e.g., 212 in FIG. 2) in combination with the MLPs (e.g., 210A-210C in FIG. 2) to reconstructed features (e.g., 108A-108C in FIG. 2).

At step 410, a loss objective the average set of feature vectors and the mapped set of representations, wherein the network of layers in the MLP are constant is computed. For example, the loss objective between the average set of feature vectors (e.g., 212 in FIG. 2) and the mapped set of representations (e.g., 108A in FIG. 2), wherein the network of layers in the plurality of MLPs (e.g., 210A in FIG. 2) are constant is computed.

At step 412, the memory bank vectors (e.g., 212 in FIG. 2) are updated by minimizing the computed loss objective. The memory bank vectors are the ensemble vector representation of the plurality of pre-trained feature vectors.

FIG. 5B is a simplified pseudocode illustrating an example process corresponding to process 400 in FIG. 5A for training a model for computing an ensemble vector representation of a plurality of pre-trained feature extractors, according to embodiments described herein. In an example, the system 100 as shown in FIG. 1, may include code for training the model. The system 100 may include a set of machine learning instructions that may be interpreted by the processor to train the ensemble representation based on the trained model as described above with reference to FIG. 5A.

### Example Performance

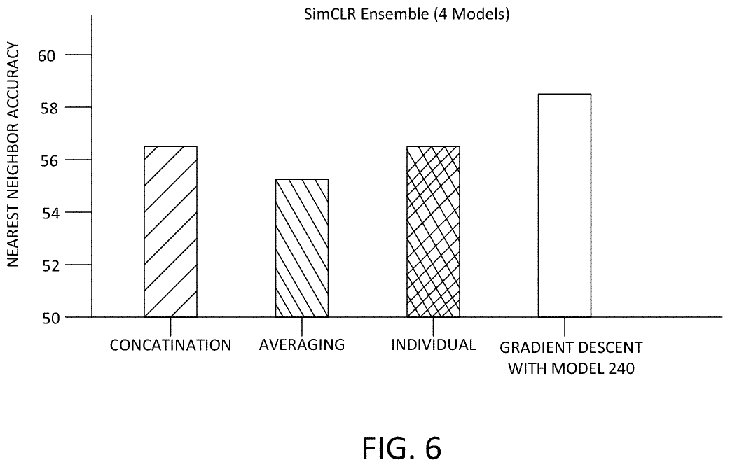

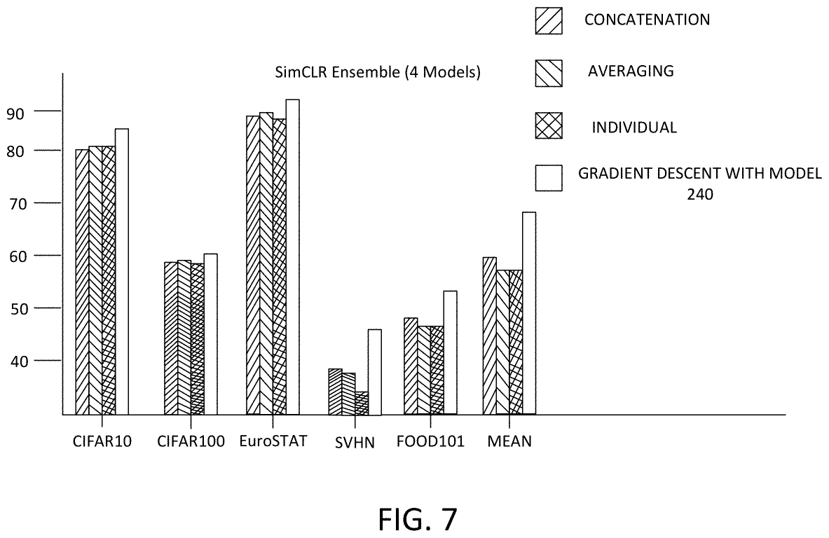

FIGS. 6 and 7 illustrate an embodiment of the current method on an ensemble consisting of 4 SimCLR models. FIG. 6 demonstrates the efficacy of an embodiment of the current model in training an ensemble representation on the source dataset, ImageNet. FIG. 7 illustrates an embodiment of the current model, based on the Nearest neighbor accuracies on the validation split of ImageNet shows an improved over all baselines by over 2%. In an embodiment of the current model for training an ensemble representation, when applied to non-ImageNet datasets and leveraging the generalization of the pretrained feature extractors, the embodiment of the current model shows improved performance across all datasets.

In an example, an embodiment of the current model may be trained in a self-supervised method on the dataset, which extracts an additional 2% of performance which increases the nearest-neighbor accuracy to over 58%.

In an example, as shown in FIG. 5, an embodiment of the current method learns on novel datasets, such as in a self-supervised transfer learning. In an example, labels are not made available until evaluation. In an example, during evaluation the k-NN accuracy is measured. In an example, via the frozen SimCLR features extractors, an embodiment of the current model learns representations which achieve over 2.5% higher k-NN accuracy on average, (over Averaging on EuroSat).

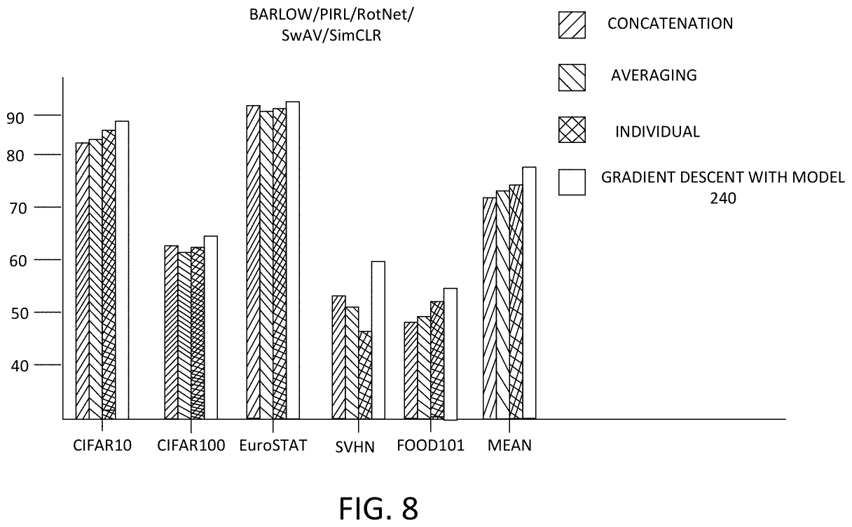

In an embodiment, of the current model the ensemble in FIG. 8 may be based on an ensemble consisting of five differently trained self-supervised models: Barlow Twins, PIRL, RotNet, SwAV, and SimCLR. In an example, this ensemble represents various approaches to self-supervised learning: SwAV and SimCLR are more standard contrastive methods, while Barlow Twins achieves state-of-the-art performance using an information redundancy reduction principal. SwAV is a clustering method in the vein of DeepCluster (Caron et al., Deep clustering for unsupervised learning of visual features. In Proceedings of the European Conference on Computer Vision (ECCV), pp. 132-149, 2018) and RotNet is a heuristic pretext from the family of Jigsaw or Colorization (Noroozi & Favaro, A simple framework for contrastive learning of visual representations. arXiv preprint arXiv: $2002.05709,2020. 2016 and Zhang et al., Deep residual learning for image recognition. In Proceedings of the IEEE conference on computer vision and pattern recognition, pp. 770-778, 2016). In an embodiment of this method, the Barlow Twins are used as the “Individual” comparison because this model achieves the highest individual k-NN accuracy on every dataset. In an embodiment of this method, the varying strengths of the underlying ensembled models is challenging as noisy signal from the weaker models may drown out that of the strongest and the varied pretraining methods results in different strengths. For example, RotNet is the weakest model of the ensemble with an average transfer k-NN accuracy of about $10% lower than other models. In an example, on a SVHN (a digit recognition task), the RotNet model performs better than non-Barlow methods by 4% (the efficacy of such geometric heuristic tasks on symbolic datasets as previously been noted in (Wallace & Hariharan, Extending and analyzing self-supervised learning across domains, 2020). In an example, the model of the current embodiments achieves an 8.2% better accuracy compared with Barlow Twins 8.2% on this dataset. In an example, an embodiment of the current method may effectively include multiple varying sources of information.

With reference to FIG. 8. the effect of using an embodiment of the current model on a supervised ensemble is shown. In an example, the pretraining goals of the models are aligned and thus traditional techniques (e.g., prediction averaging) may be used. In an example, an embodiment of the current method improves on the ensembled intermediate features which indicates the model is agnostic towards pretraining tasks.

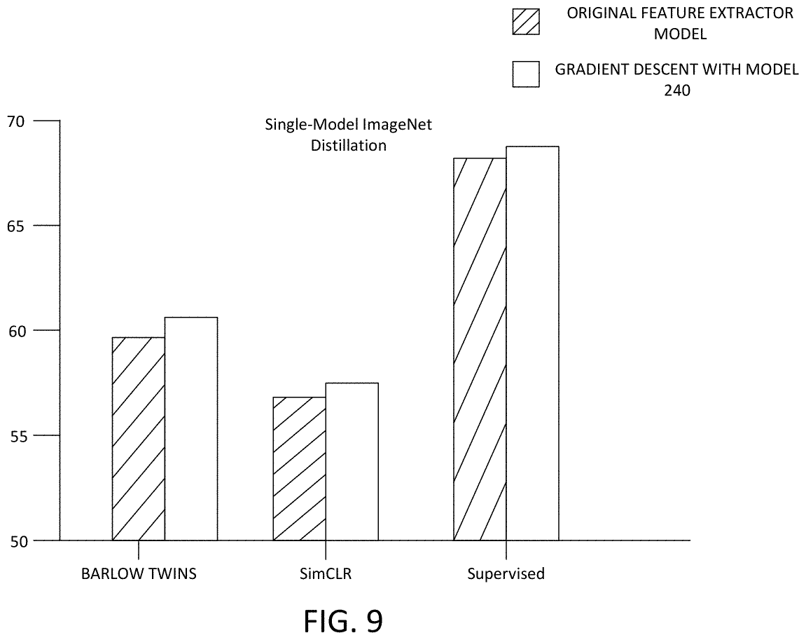

With reference to FIG. 9 In an embodiment of the current model, the training is based on an ensembling technique. In an embodiment of the current model may also be effective when employed on a single model. An embodiment of the current model improves the features without access to their corresponding images or additional supervision. In an example, an embodiment of the current model improves features with identical input initialization and targets. In an embodiment of the current model, the MLP, ϕ, does not converge to a perfect identity function during the warmup period and the movement of the representations ψ helps enable near-perfect target recovery. During the inference stage, in an embodiment of the current model the MLP output of the average feature is close to identity (0.97 cosine similarity). In an embodiment of the current model, the model captures specialties/strengths of the component feature extractors, particularly the symbolic-dataset efficacy of RotNet.

In an example, as shown in FIG. 9 an embodiment of the current model provides performance gains that parallel the efficacy of self-distillation (Zhang et al. Improve the performance of convolutional neural networks via self-distillation, In Proceedings of the IEEE/CVF International Conference on Computer Vision (ICCV), October 2019), when just one model is employed. In an embodiment of the current model, the model without utilizing the consistency of the supervised classification objective, combines supervised models to improve upon the performance of other ensembles.

In an embodiment, of the current model the model performs better on datasets with a mean improvement of 1% when used on a single Barlow Twins model. In an example, an embodiment of the current method learns the representation through gradient descent and the similarity improves to near perfect 0.99+ similarity.

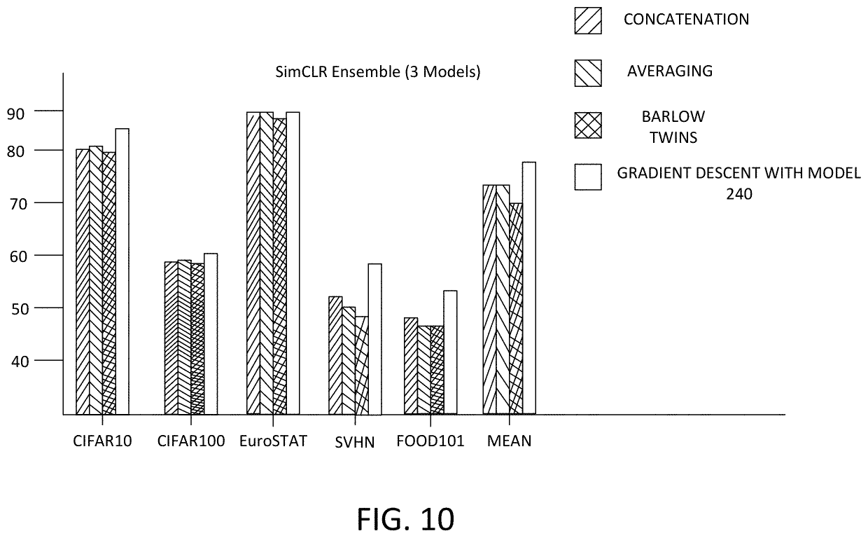

With reference to FIG. 10 in an embodiment, of the current model the “assembling” technique benefits all individual models substantially (1.8, 1.3 and 0.4% respectively) when the representations of the models of the current embodiment are trained on ImageNet. In an example, an embodiment of the current model even after optimization of the original self-supervised model objectives, shows a high the margin of the improvement. In an example, of the current model the benefit carries over the self-supervised transfer learning as well. In an example, an embodiment of the current model in conjunction with a Barlow Twins mode offers a mean k-NN accuracy gain of over 1%, without additional information, augmentations, or images being made available other than the CNN's features. In an example, an embodiment of the current method performs better compared to the baseline features across a wide range of hyperparameter choices.

In an embodiment of the current model, the MLPs, Φ, are trained on the same dataset as the representations Ψ, where inference is performed. In an embodiment, of the current model the MLPs are trained on a dataset may be re-used to learn representations Ψ on arbitrary imagery.

In an embodiment of the current model, involving a single-model case, transferring ϕ still provides benefit over the baseline, but is less effective than learning the MLPs per dataset. the MLPs are frozen, no parameters of any networks are being changed during training, solely the representations Ψ are being learned. For example, in the ensemble setting, the performance of an embodiment of the current model is maintained when re-using MLPs from ImageNet.

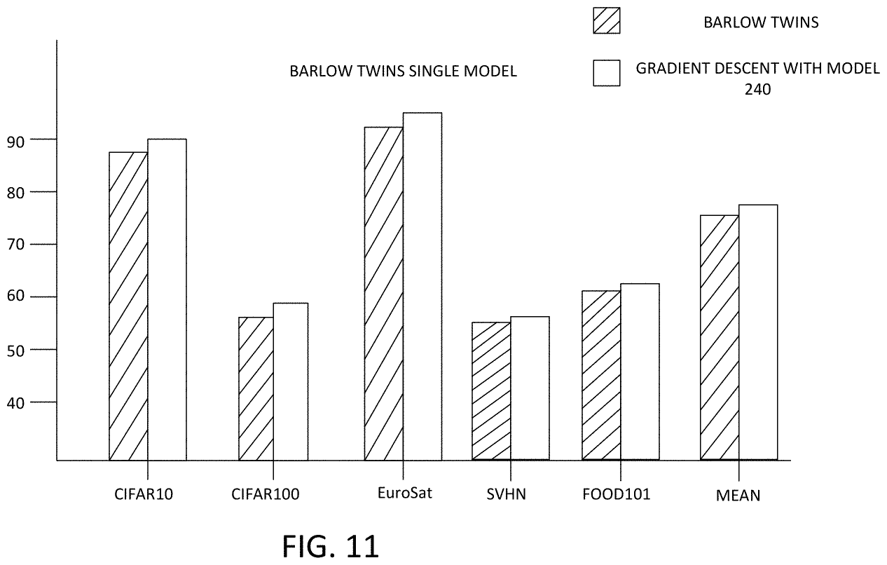

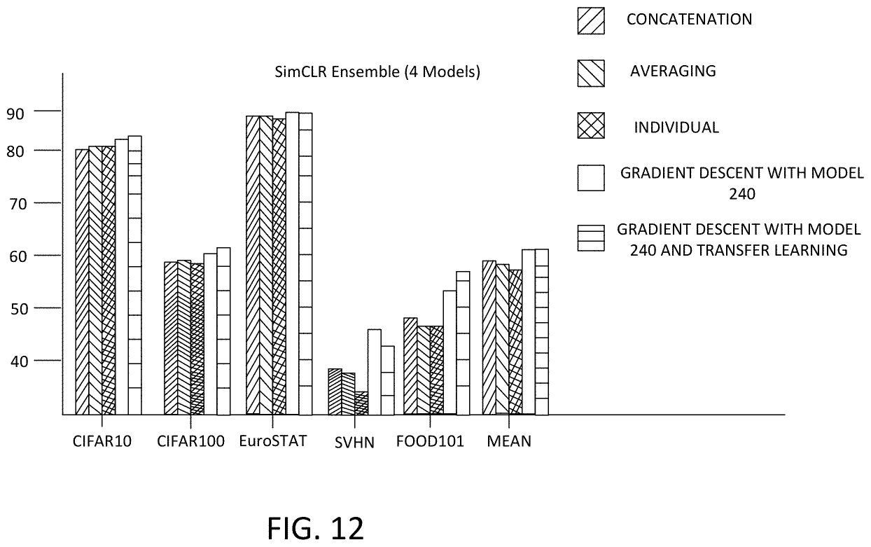

With reference to FIG. 11, in an embodiment of the current model in the single model setting, the Barlow Twins model+MLP trained on ImageNet is re-used across transfer datasets, the transferred model still maintains improvement over the baseline on 4 out of 5 datasets (all but Eurosat).

In an embodiment, of the current model the efficacy of the method in the single-model setting is based on ϕ acting as a regularizer. In an embodiment, of the current model it should be understood that a person of skill in the art could substitute a different regularization method or a non-regularization method.

In an embodiment of the current model varying the depth of Φ from 1 to 8 layers while learning representations directly on our varied dataset benchmark using a Barlow Twins model improves accuracy incrementally until the network is 6 layers deep, more than triple that of the default setting. In an embodiment of the current model some of this performance boost is recoverable by adding in small amounts of traditional weight decay (e.g., 1e-6) to the parameters of the MLP.

In an embodiment of the current model ablation of MLP depth, indicates that the low-rank tendency of deeper networks serves as a regularize on the learned representations. The low-rank tendency of deeper networks results in improved representation quality with network depth up to 6 layers.

In an embodiment of the current method, the sorted singular value curves for an embodiment of the current model compared to the baseline features when compared with similar settings (e.g., learning ϕ restricted to nonnegative) indicates the current embodiment of the model learns features with a more balanced set of singular values, indicating a more uniformly spread bounding space.

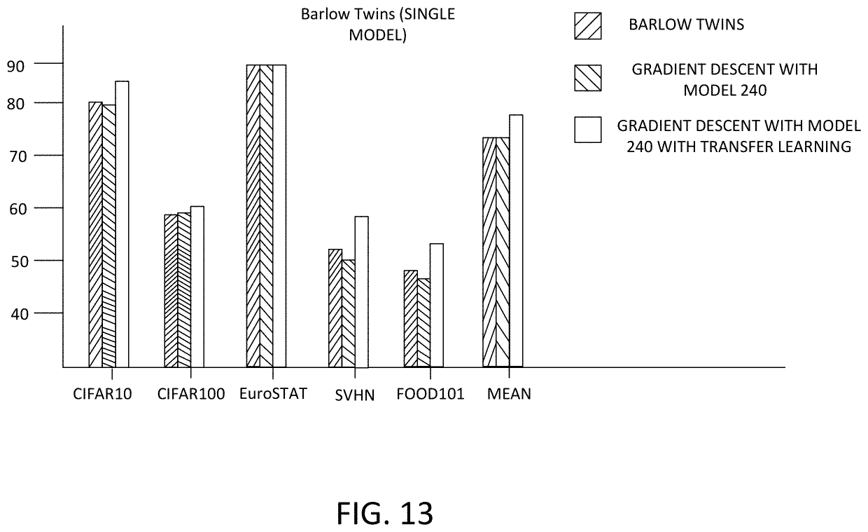

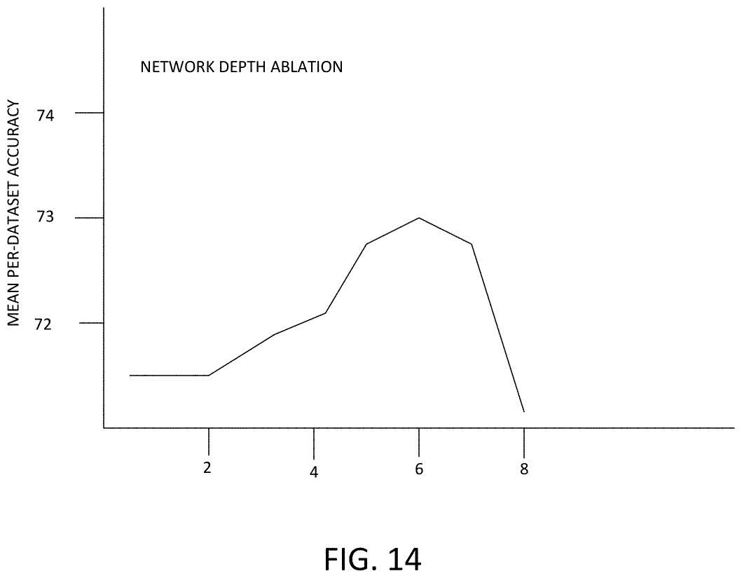

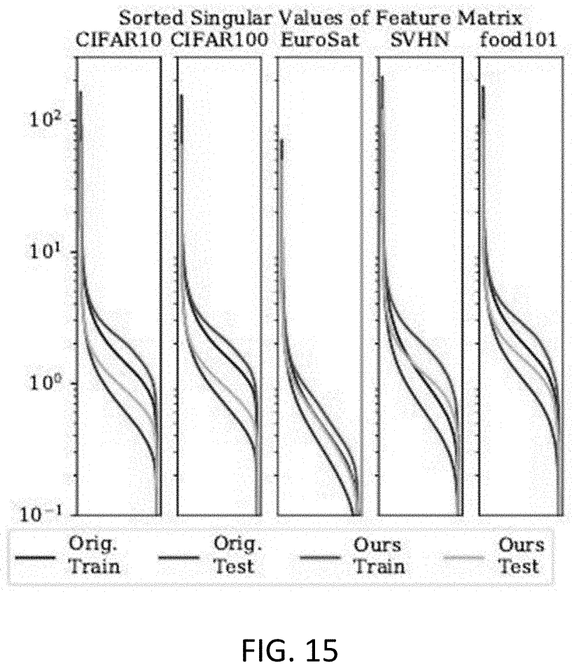

With reference to FIG. 13-15, in an embodiment of the current model the distribution of Ψ is compared by training representations from a single Barlow Twins model while restricting the points to be non-negative (i.e., in the first n-tant of feature space), to make a comparison with similar settings to the baseline features. In an example, an embodiment of the current model compares the singular values of this (constrained) feature matrix to that of the original features. In general, the singular value distribution of Ψ is less heavy tailed. In an embodiment of the current model the volume occupied by the features is larger and more uniform in each dimension than the baseline features. In an example, of the current embodiment of the current model the Ψ learning a regularized form of the original Z. In an embodiment of the current model the feature representations are spread out because of the learning process. An embodiment of the current model, the improvement is partially attributable to accentuation of existing clusters in the dataset.

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure. Like numbers in two or more figures represent the same or similar elements.

In this description, specific details are set forth describing some embodiments consistent with the present disclosure. Numerous specific details are set forth to provide a thorough understanding of the embodiments. It will be apparent, however, to one skilled in the art that some embodiments may be practiced without some or all these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and, in a manner, consistent with the scope of the embodiments disclosed herein.

What is claimed is:

1. A method for training a model for computing an ensemble vector representation of a plurality of pre-trained feature extractors comprising:
receiving, via a communication interface, a dataset of a plurality of data samples;
determining, in response to a sample from the dataset, a set of feature vectors via a plurality of pre-trained feature extractors, respectively;
retrieving a memory bank vector that is initialized corresponding to the plurality of data samples from the dataset;
mapping, via a plurality of Multi-Layer-Perceptron (MLPs), the memory bank vector into a plurality of mapped representations, respectively;
computing a loss objective between the set of feature vectors and the plurality of mapped representations; and
updating the plurality of MLPs and the memory bank vector based on the computed loss objective.

2. The method of claim 1, wherein the plurality of pre-trained feature extractors is selected from one or more of the pre-trained feature extractors that include different head architectures.

3. The method of claim 1, wherein the plurality of pre-trained feature extractors is selected from one or more of the pre-trained feature extractors that are trained on different objectives.

4. The method of claim 1, wherein the dataset includes a plurality of images.

5. The method of claim 1, wherein the dataset includes a plurality of text documents or a plurality of audio files.

6. The method of claim 1, wherein the dataset includes a plurality of point clouds or polygon meshes.

7. The method of claim 1, wherein the method further comprises:
freezing the parameters of the plurality of updated MLPs.

8. A method for computing via a trained model an ensemble vector representation of a plurality of pre-trained feature vectors comprising:
receiving, via a communication interface, an interpretation data sample;
determining, in response to the interpretation data sample, a set of feature vectors via a plurality of pre-trained feature extractors, respectively;
determining an average of the set of feature vectors;
mapping, via a plurality of Multi-Layer-Perceptron (MLPs), the initialized memory bank vector into a plurality of mapped representations, respectively;
computing a loss objective between the set of feature vectors and the plurality of mapped representations; and
updating the initialized memory bank vector based on the computed loss objective while freezing the plurality of MLPs.

9. The method of claim 8, wherein the plurality of pre-trained feature extractors is selected from one or more of the pre-trained feature extractors that are trained on different objectives.

10. The method of claim 8, wherein the data sample includes a plurality of images.

11. The method of claim 8, wherein the data sample includes a plurality of text documents or a plurality of audio files.

12. The method of claim 8, wherein the data sample includes a plurality of point clouds or polygon meshes.

13. A system for training a model for computing an ensemble of unsupervised vector representations, the system comprising:
a communication interface for receiving a query for information;
a memory storing a plurality of machine-readable instructions; and
a processor reading and executing the instructions from the memory to perform operations comprising:
receive, via a communication interface, a dataset of a plurality of data samples;
determine, in response to an input data sample from the dataset, a set of feature vectors via a plurality of pre-trained feature extractors, respectively;
retrieve a set of memory bank vectors that correspond to the input data sample;
generate, via a plurality of Multi-Layer-Perceptrons (MLPs), a mapped set of representations in response to an input of the set of memory bank vectors, respectively;
compute a loss objective between the set of feature vectors and the combination of the mapped set of representations and a network of layers in the MLP; and
update the plurality of MLPs and the memory bank vectors by minimizing the computed loss objective.

14. The system of claim 11, wherein the plurality of pre-trained feature extractors is selected from one or more of the pre-trained feature extractors that include different head architectures.

15. The system of claim 11, wherein the plurality of pre-trained feature extractors is selected from one or more of the pre-trained feature extractors that are trained on different objectives.

16. The system of claim 12, wherein the dataset includes a plurality of images.

17. The system of claim 12, wherein the dataset includes a plurality of text documents or a plurality of audio files.

18. The system of claim 12, wherein the dataset includes a plurality of point clouds or polygon meshes.

19. The system of claim 12, wherein the plurality of pre-trained feature extractors is selected from a plurality of convolutional neural network.

20. The system of claim 11, including further instructions to perform operations comprising:
freezing, the parameters of the plurality of updated MLPs;
receiving, via a communication interface, an interpretation data sample;
determining, in response to the interpretation data sample, a set of feature vectors via a plurality of pre-trained feature extractors, respectively;
updating the memory bank vector using an average of the set of feature vectors;
mapping, via a plurality of Multi-Layer-Perceptron (MLPs), the initialized memory bank vector into a plurality of mapped representations, respectively;
computing a loss objective between the set of feature vectors and the plurality of mapped representations; and
updating the initialized memory bank vector based on the computed loss objective while freezing the plurality of MLPs.
